(19) United States
(12) Patent Application Publication
(10) Pub. No.: US 2003/0224637 A1
(43) Pub. Date: Dec. 4, 2003

(54) Plug socket securing device for use with plug socket having a slot formed by a resilient tab

(76) Inventor: Renny Tse-Haw Ling, Chung-Ho City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/339,534

(22) Filed: Jan. 9, 2003

(30) Foreign Application Priority Data
May 31, 2002 (TW) 091208180

(51) Int. Cl. H01R 13/44

(52) U.S. Cl. 439/133

(57) ABSTRACT

A plug socket securing device, particularly one for use with an equipment provided with a plug socket having a slot formed by a resilient tab on the plug socket and features electrical or signal transmission function, comprising, a closure to be inserted into the plug socket for covering the plug socket; at least one fastener connected to the closure and being movable, in relation to the closure, between a first position, allowing the closure to attach and detach from the slot of the socket plug and a second position preventing the closure inserted in the plug socket from detaching from the plug socket; and a lock mechanism, assembled to the closure for actuating the fastener, the lock mechanism being switchable between an unlocked state and a locked state, where in the unlocked state, the lock mechanism forces the fastener to be retrained to the second position so as to prevent the plug socket from connecting to other articles. Based on such disclosures, this invention may further provide a connecting element, such as a cable, on the closure or the lock mechanism, wherein the connecting element affixes the equipment having the plug socket to a fixture, such as a table, thereby preventing theft of the equipment. Under the state where the equipment is affixed to the fixture, the plug socket may further provide an interface connected to the plug socket where the interface may be connected to other objects, such as a transmission line, thereby allowing indirect connection with the plug socket.

### FIELD OF INVENTION

This invention is related to a plug socket securing device, particularly one for use with an equipment provided with a plug socket having a slot formed by a resilient tab on the plug socket and features electrical or signal transmission function.

### BACKGROUND OF INVENTION

With the rapid development of the modern society, the application of electronic equipments and computers has become very common. The current computer, either a desktop computer or a laptop computer 1, as shown in FIG. 1, has a plurality of connector ports, each port including at least one slot formed by a resilient tab of the plug socket of the port, such as a Universal Serial Bus (USB) port plug 10 for connecting a USB interface.

However, the existence of a USB interface may allow unauthorized persons to connect to an appropriate hardware, such as a portable hard diskette drive or a CD-R drive to steal the data files from the electronic equipment by connecting a transmitting cable to the plug. Thus, there is a need to provide a device to prevent unauthorized connection to the plugs of the electronic equipment.

Furthermore, as they have become lighter and more compact, electronic equipments including fax machines, printers, or laptop computers that are compact in size, may be easily stolen. To attack such a problem, known measures for securing such electronic equipments include furnishing the equipment with a custom security device on the equipment casing, the security device then being locked to a lock or cable lock device provided on a fixture, such as those disclosed in U.S. Pat. No. 6,389,853 and U.S. Pat. No. 6,401,502.

### SUMMARY OF INVENTION

In view of the above problems, a primary objective of this invention is to provide a plug socket securing device, particularly one for use with an equipment provided with a plug socket having a slot formed by a resilient tab on the plug socket and features electrical or signal transmission function, for securing and locking the plug socket (such as a USB port or a fire wire port), the plug socket securing device comprising: a closure to be inserted into the plug socket for covering the plug socket; at least one fastener connected to the closure and being movable, in relation to the closure, between a first position which allows the closure to attach and detach from the slot of the socket plug and a second position which prevents the closure inserted in the plug socket from being detached from the plug socket; and a lock mechanism, assembled to the closure for actuating the fastener, the lock mechanism being switchable between an unlocked state and a locked state, where in the unlocked state, the lock mechanism forces the fastener to be restrained to the second position.

As such, this invention helps to seal and lock the closure in the plug socket, such that connection of other hardware or transmission lines to the plug socket by unauthorized persons are prevented.

Another objective of this invention is to provide an interface connected to the plug socket that may be connected to other hardware equipments or transmission lines, thereby allowing indirect connection to the plug socket under the state where the equipment is affixed to the fixture through a connecting element.

The structures and characteristics of this invention can be realized by referring to the appended drawings and explanations of the preferred embodiments.

### BRIEF DESCRIPTION OF DRAWINGS

FIG. 1 is a perspective, schematic view of a currently available laptop computer equipped with a USB port.

FIG. 1(a) is a perspective view of a USB port.

FIG. 1(b) is a cross-sectional view taken along lines 1b-1b of FIG. 1(a).

FIG. 2 is a perspective, schematic view showing a preferred embodiment of this invention.

FIG. 3 is a perspective, exploded view of the embodiment in FIG. 3.

FIGS. 4(a) to 4(c) are cross-sectional views of the embodiment in FIG. 2, illustrating the operations where the closure engages the plug socket, in which FIG. 4(c) illustrates the fastener under its first position.

FIGS. 5(a) to 5(b) are cross-sectional views of the embodiment in FIG. 2, illustrating the operations after the closure engages the plug socket, and a connecting element being in a restraining state, in which FIG. 5(a) illustrates the fastener under its second position.

FIG. 6(a) is a cross-sectional view of another embodiment of this invention, illustrating the fastener under its first position, and the lock mechanism under its unlocked state.

FIG. 6(b) is a partially cross-sectional view of the embodiment in FIG. 6(a), illustrating the fastener under its second position, and the lock mechanism under its locked state.

FIG. 7(a) is a partially cross-sectional view of another embodiment of this invention, illustrating the fastener under its first position, and the lock mechanism under its unlocked state.

FIG. 7(b) is a partially cross-sectional view of the embodiment in FIG. 7(a), illustrating the fastener under its second position, and a connecting element being in place.

FIG. 7(c) is cross-sectional end view of the embodiment in FIG. 7(a) taken along lines 7c-7c of FIG. 7(b), illustrating the fastener under its second position, and a connecting element being in a restraining state.

FIG. 8(a) is a partially cross-sectional view of another embodiment of this invention, illustrating the fastener under its first position, and the lock mechanism under its unlocked state.

FIG. 8(b) is a partially cross-sectional view of the embodiment in FIG. 8(a), illustrating the fastener under its second position, and a connecting element in place.

FIG. 8(c) is a cross-sectional end view of the embodiment in FIG. 8(a), illustrating the fastener under its second position, and a connecting element being in a restraining state.

FIG. 9 is a schematic view showing the embodiments of FIGS. 2, 6, 7, and 8 under the state of use.

FIG. 10 is a perspective, schematic view showing another preferred embodiment of this invention.

FIG. 11 is a perspective, exploded view of the embodiment in FIG. 10.

FIG. 12 is a cross-sectional, schematic view of the embodiment in FIG. 10, illustrating the fastener under its first position.

FIG. 13 is a cross-sectional, schematic view of the embodiment in FIG. 10, illustrating the fastener under its second position.

NOMENCLATURES OF ELEMENTS

| | |
|---|---|
| 1 | laptop computer |
| 2 | securing device |
| 10 | plug socket |
| 11 | slot |
| 12 | resilient tab |
| 20 | closure |
| 21 | tab |
| 22 | lock opening |
| 24 | locking arm |
| 27 | c-clip |
| 28 | connecting element |
| 29 | support |
| 32 | pivot |
| 34 | lock opening |
| 46 | lock case |
| 48 | control member |
| 60 | key lock |
| 62 | key |
| 70 | drawing lock |
| 71 | control button |
| 73 | lock opening |
| 80 | rotary lock |
| 81 | control button |
| 82 | cam face |
| 83 | lock opening |
| 90 | drawing lock |
| 91 | control member |
| 93 | lock opening |
| 120 | bypass interface |
| 122 | electrical component |
| 123 | circuit board |
| 130 | control key |
| 132 | lock opening |
| 150 | table leg |
| 211 | claw |
| 241 | control end |
| 242 | claw end |
| 243 | compression spring |
| 244 | leaf spring |
| 281 | loop |
| 282 | padlock |
| 421 | protrusion |
| 462 | window |
| 481 | cam face |
| 911 | urging end |

### DETAILED DESCRIPTIONS OF EMBODIMENTS

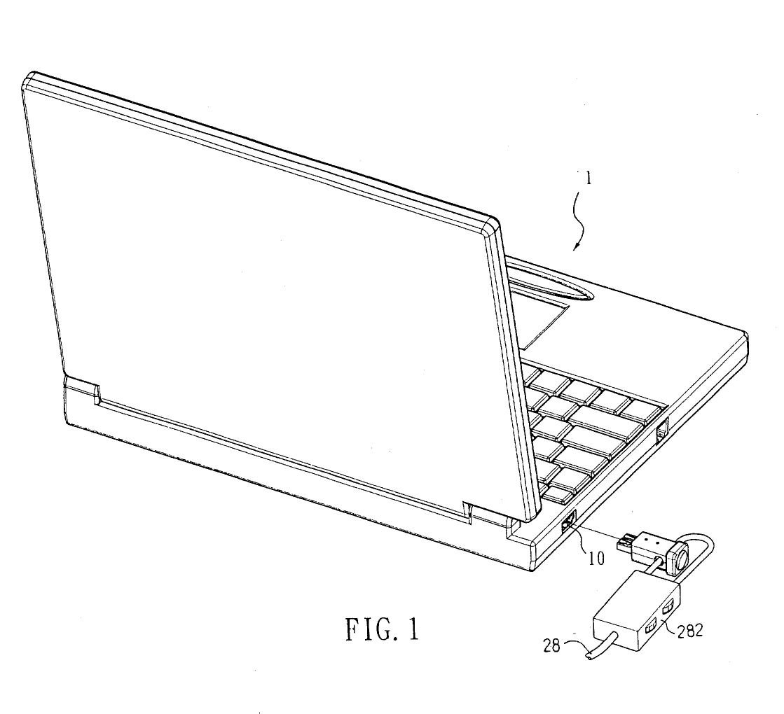

This invention is mainly related to a plug socket securing device 2, for securing a plug socket 10 provided on an electronic equipment, such as a communication device, a desktop computer or a laptop computer 1, as shown in FIG. 1.

The perspective view of the plug socket 10 is shown in FIG. 1(a). FIG. 1(b) is a cross-sectional view taken along lines 1b-1b of FIG. 1(a). The plug socket 10 includes at least one slot 11 formed by a resilient tab 12 and is featured with electrical or signal transmission function, such as a USB port plug.

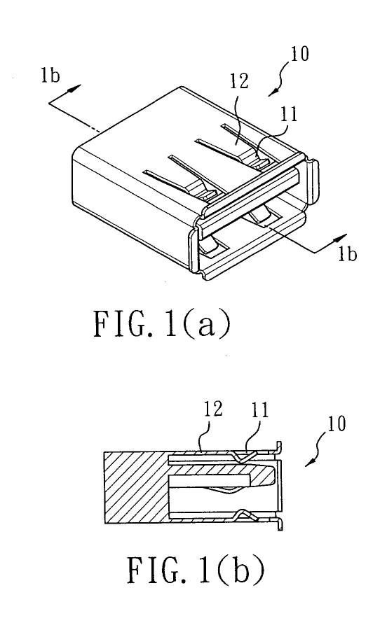

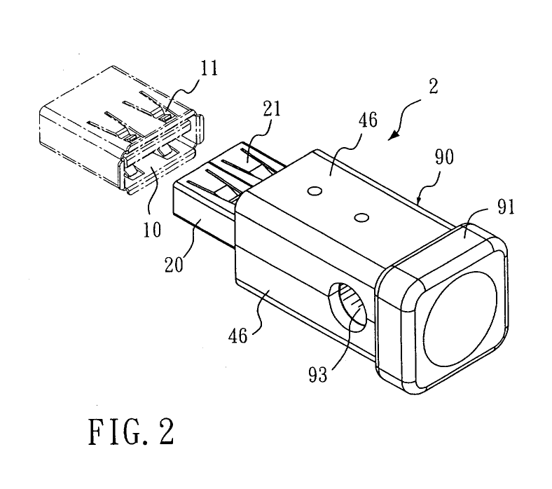

FIG. 2 illustrates a perspective view of a preferred embodiment of this invention. FIG. 3 is an exploded, perspective view of this embodiment. By referring to FIGS. 2 and 3, the plug socket securing device 2 in this embodiment includes: a closure 20 to be inserted into the plug socket 10 for covering the plug socket 10; at least a fastener or a resilient body, such as a tab 21 joined to the closure 20 and being movable, in relation to the closure 20, between a first position which allows the closure 20 to attach and detach from the socket plug 10 and a second position which prevents the closure 20 inserted in the plug socket 10 from being detached from the plug socket 10, wherein the tab 21 includes a claw 211 that hooks to the slot 11 of the plug socket 10 at the second position; a lock mechanism, assembled to the closure 20 and being switchable between an unlocked state and a locked state, wherein in the unlocked state, the lock mechanism forces the tab 21 to be restrained to the slot 10 in the second position.

This embodiment adopts a drawing lock 90 as the lock mechanism. The drawing lock 90 includes: a lock case 46 formed with a lock opening 93; a control member 48 formed with a corresponding lock opening 93, the control member 48 being movable in relation to the lock case 46 in a linear manner, to urge against the resilient body 21 to the second position, in the unlocked stated, the control member 48 being movable in relation to the lock case 46; and a control shaft 91 integrally formed by the control member 48 and has an urging end 911.

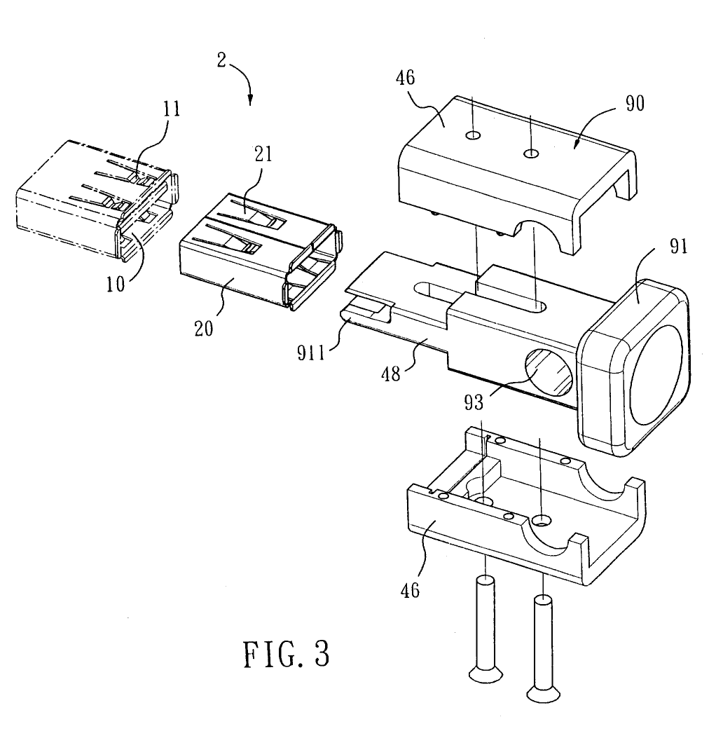

FIGS. 4(a) to 4(c) illustrate the states prior to where the closure 20 engage the plug socket 10, in which FIG. 4(c) illustrates the fastener/resilient body in its first position.

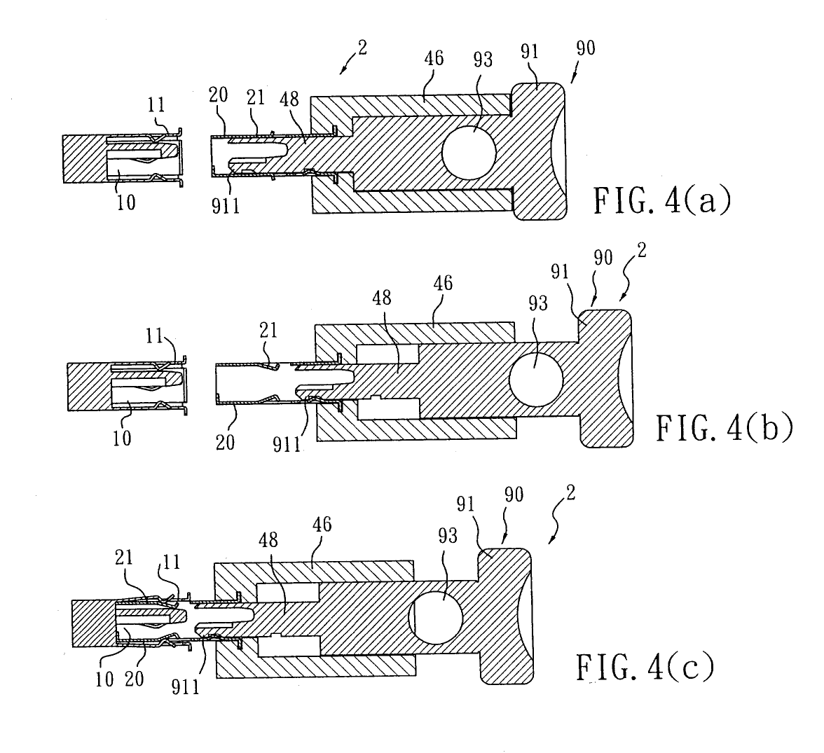

While using the securing device 2 of this embodiment, the user draws the control shaft 91 such that the urging end 911 integrally formed by the control member 48 does not urge against the tab 21 of the closure 20. At this time, the closure 20 may be inserted into the plug socket 10. When the control shaft 91 is pushed such that the urging end 911 of the control member 48 urges against the tab 21 on the closure 20, the tab 21 will engage a slot 11 formed in the plug socket 10, as shown in FIG. 5(a).

When the urging end 911 is restrained in the second position, the corresponding lock opening 93 adopts to allow a connecting element 28 or a padlock 282, as shown in FIG. 1, to pass through, thereby limiting the movement of the control member 48. Therefore, by passing the connecting element 28 through the lock openings 93 of the lock case 46 and control member 48, movement of the control shaft 91 in the drawing lock 90 may be prevented, as shown in FIG. 5(b), thereby turning the drawing lock 90 into the locked state, that is, the second position. Therefore, the tab 21 of the closure 20 is locked in the slot 11 of the plug socket 11 and cannot be detached.

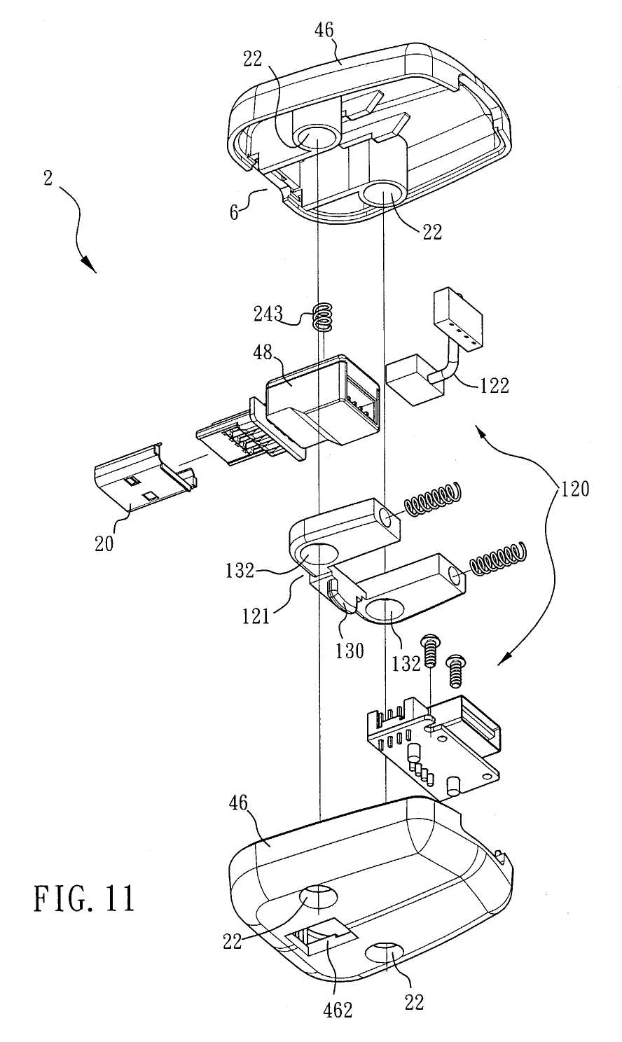

In this embodiment, the connecting element 28 may also be wrapped about a fixture, such as a table leg 150, as that shown in FIG. 12. A locking apparatus may further be provided to lock the connecting element 28 to the fixture 150, so as to secure the communication equipment or computer 1 to the fixture 150.

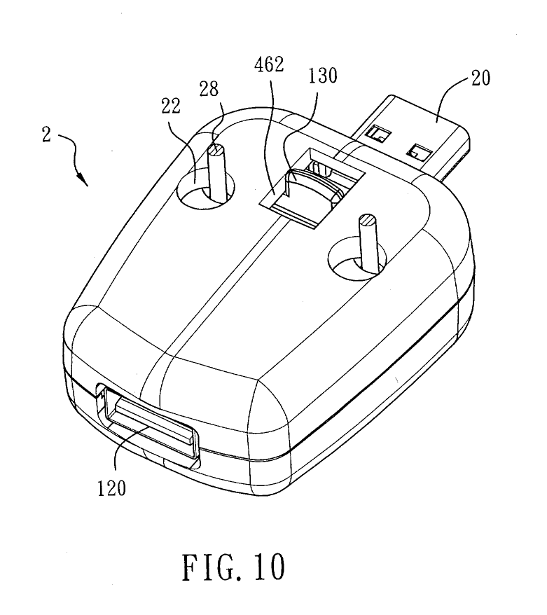

The tab 21 type fastener as shown in FIGS. 2-5 is furnished to accommodate the standard plug socket 11 of a USB port 10, as shown in FIG. 11. Such a tab 21 type fastener may also be of other configurations that comply with other standard plug sockets having slots, such as a wire fire socket; such modifications can be made easily by persons skilled in the art.

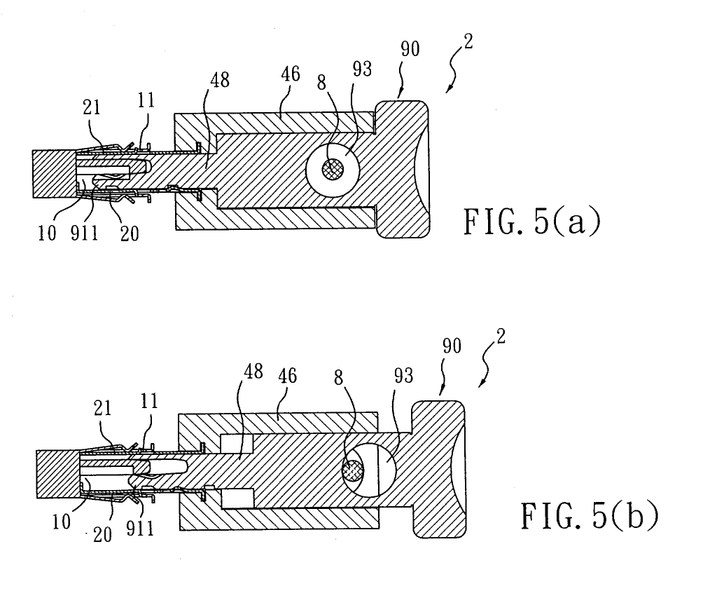

FIG. 6(a) is a cross-sectional view showing another embodiment of this invention. In this embodiment, the plug socket securing device 2 comprises a closure 20 substantially configured complementary to the shape of the USB plug socket 10, to be inserted into the plug socket 10 for covering the plug socket 10. The closure 20 of the plug socket securing device 2 in this invention includes at least one fastener, such as a locking arm 24 shown in this embodiment. The locking arm 24 is movable, in relation to the closure 20, between a first position (as shown in FIG. 6(a)) that allows the closure 20 to attach and detach from the socket plug 10 and a second position (as shown in FIG. 6(b)) that prevents the locking arm 24 of the closure 20 inserted in the plug socket 10 from being detached from the slot 11 of the plug socket 10.

The securing device 2 includes a lock mechanism that may be locks of any type, such as the key lock 60 shown in FIGS. 6(a) and 6(b), so long as the lock mechanism is able to lock the locking arm 24 of the closure 20 to the slot 11 of the plug socket 10. The constructions of the lock mechanism are not limited to those disclosed in the embodiments. The lock mechanism is assembled to the closure 20 and co-acts with the fastener/locking arm 24. The lock mechanism is switchable between an unlocked state and a locked state. In the unlocked state, the lock mechanism forces the fastener/locking arm to be restrained to the second position.

According to this embodiment, a pivot 32 is provided to the lock mechanism for pivoting the locking arm 24, and allowing the locking arm 24 of the closure 20 to pivot about the pivot 32. The locking arm 24 includes a control end 241 and a claw end 242 located at its free end. The lock mechanism is a lock having a lock case 46; a control member 48 movable in relation to the lock case 46 for urging the fastener/locking arm 24 to the second position. The control member 48 is a pin that applies forces to the control end 241 of the locking arm 24 in response to the operation of the lock mechanism. In the unlocked state, the control member 48 is movable in relation to the lock case 46. Of course, the engagement between the control member and the locking arm 24 may adopt configurations not limited to that disclosed in this embodiment.

The detailed structures and locking measures of the key lock 60 in relation to the closure 20 utilized in the preferred embodiment of this invention are known to persons skilled in the art. It should be noted that the lock mechanism can be variously designed to achieve the objects of this invention and should not be limited to those disclosed in the preferred embodiments.

In the embodiment of FIGS. 6(a) and 6(b), FIG. 6(a) shows the key lock 60 in the unlocked state, that is, the control member 48 is driven by a key 62 so as to not urge against the locking arm 24. The claw end 242 of the locking arm 24 is detachable from the plug socket 10 due to the resilience of a compression spring 243 applied to the control end 241, and maintains at the first position. When the control member 48 is driven by the key 62 to rotate such that the control member 48 urges against the locking arm and turns the key lock 60 into the locked state, as shown in FIG. 6(b), the locking arm 24 is consequently driven by the control member 48 so as to move to the second position to where the claw end 242 tightly attaches to the slot 11 of the plug socket 10, whereby the closure 20 cannot be detached from the plug socket 10.

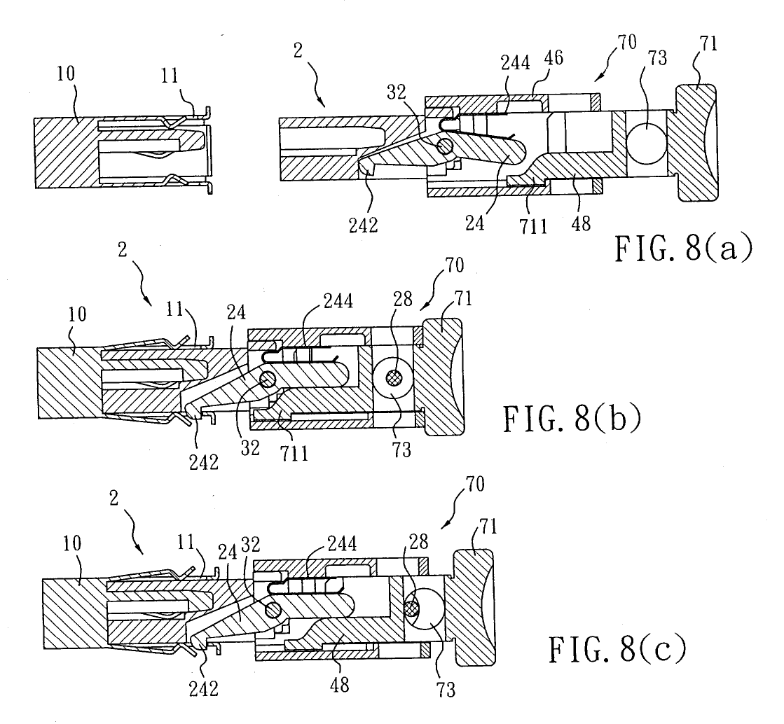

The lock mechanism may further be affixed with a connecting element, such as a cable or a chain, such that after the closure 2 seals and secures the plug socket 10, the connecting element may affix the equipment having a plug socket 10 to a fixture, such as a table, thereby preventing theft of the equipment, if desired. The securing device 2 may further be affixed with a connecting element 28, such as a cable or a chain. An end of the connecting element 28 may form a loop 281, as shown in FIG. 9. However, it should be noted that such connecting element provides additional securing effects to the present invention, but is not intended to limit the scope. In other words, in this embodiment, the object of covering and securing the plug socket 10 may still be achieved without the provision of the connecting element 28.

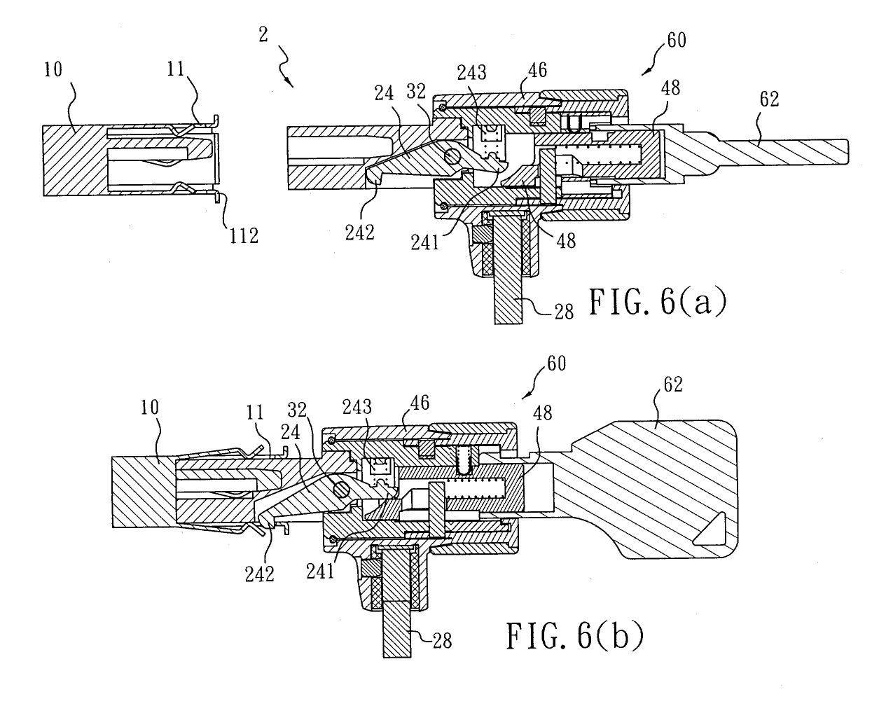

In the embodiment of FIGS. 7(a) to 7(c), FIG. 7(a) shows the securing device 2 of this invention implementing a rotary lock 80. The rotary lock 80 includes: a lock case 46 formed with a lock opening 83; a control member 48 formed with a corresponding lock opening 83, the control member 48 being movable in relation to the lock case 46 in a rotational manner, to urge against the control end 241 of the locking arm 24.

In this embodiment, the control member 48 includes a cam face 82 controlled by a control button 81 subjecting the cam face 82 to act on the control end 241 of the locking arm. In the unlocked state, the control member 48 is movable in relation to the lock case 46 and is clear from the control end 241 of the locking arm 24.

FIG. 7(a) illustrates the rotary lock 80 under the unlocked state, that is, the cam face 82 does not urge against the locking arm 24 because the control button 81 has yet to be rotated. As such, the claw end 242 of the locking arm 24 is detachable from the plug socket 10 because of the resilience of a compression spring 243 applied to the claw end 241, and maintains at the first position. When the control member 48 is driven by the cam face 82 of the control button 8 to rotate, the locking arm 24 is consequently driven by the cam face 82 to move to the second position to where the claw end 242 tightly attaches to the slot 11 of the plug socket 10, whereby the closure 20 cannot be detached from the plug socket 10.

In this embodiment, the lock case 46 and the control member 48 of the rotary lock 80 are each formed with a lock opening 83. The lock opening 83 allows a connecting element 28 to pass through when the locking arm 24 is at the second position, limiting the rotation of the control button 81 in relation to the control member 48, thereby turning the rotary lock 80 into a locked state, as shown in FIG. 7(c). Hence, the claw end 242 of the locking arm 24 is locked to the slot 11 of the plug socket 10 and cannot be detached. The control button 81 and the control member 48 shown in FIGS. 7(a) and 7(b) are an integral piece. Other appropriate engagements of the two may certainly be adopted.

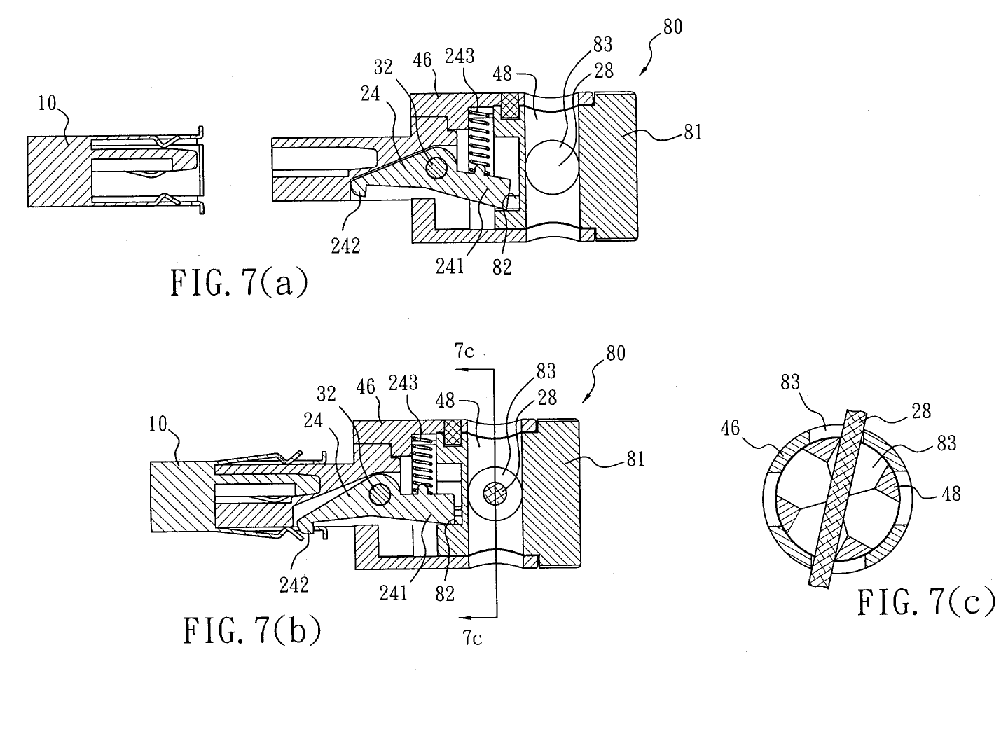

In the embodiment of FIGS. 8(a) to 8(c), FIG. 8(a) shows the securing device 2 of this invention implementing a drawing lock 70. The drawing lock 70 includes: a lock case 46 formed with a lock opening 73; a control member 48 formed with a corresponding lock opening 73, the control member 48 being movable in relation to the lock case 46 in a linear manner, to urge against the control end 241 of the locking arm 24; and a control shaft 71 integrally formed by the control member 48 and has an urging end 711.

While using the securing device 2 of this embodiment, the user draws the control shaft 71 such that the urging end 711 integrally formed by the control member 48 does not urge against the control end 241 of the locking arm 24. At this time, the closure 20 may be inserted into the plug socket 10. When the control shaft 71 is pushed such that the urging end 711 of the control member 48 urges against the tab 21 on the closure 20, the tab 21 will engage the slot 11 formed in the plug socket 10, as shown in FIG. 8(a).

When the urging end 711 is restrained to the second position, the corresponding lock opening 73 adopts to allow a connecting element 28 to pass through, thereby limiting the movement of the control member 48. Therefore, by passing the connecting element 28 or a padlock 282 as shown in FIG. 1 through the lock openings 73 of the lock case 46 and control member 48, movement of the control shaft 71 in the drawing lock 70 may be prevented, as shown in FIG. 8(c), thereby turning the drawing lock 70 into the locked state, that is, the second position. Therefore, the tab 21 of the closure 20 is locked in the slot 10 of the plug socket 10.

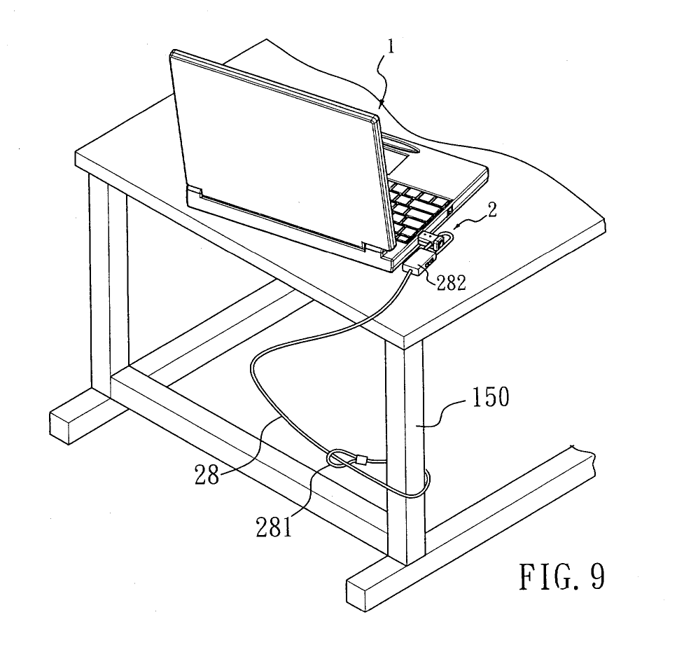

The locking arm 24 type fastener as shown in FIGS. 6-8 is furnished to accommodate the standard plug socket 11 of a USB port 10 as shown in FIG. 10. Such a locking arm 24 type fastener may also be of other configurations that comply with other standard plug sockets having slots; such modifications can be made easily by persons skilled in the art.

FIG. 10 illustrates another embodiment of this invention. FIG. 11 is an exploded, perspective of the embodiment in FIG. 10. FIG. 12 is a cross-sectional, schematic view of the embodiment in FIG. 10, illustrating the closure being detached from the plug socket. By referring to FIG. 11, the securing device 12 comprises: a closure 20; at least one fastener connected to the closure 20; a lock mechanism, assembled to the closure 20 for actuating the locking arm type fastener; a connecting element 28, having an end connecting the lock mechanism and another end connected to a fixture; and a bypass interface 120, electrically connected to the closure 20 and serves as a connection between other hardware or transmission lines and the plug socket 10 when the closure 29 covers the plug socket 10.

In this embodiment, the closure 20 may be designed to be substantially identical to those as discussed previously. In other words, the closure 20 may be substantially configured complementary to the shape of the plug socket 10, to be inserted into the plug socket 10 for covering the plug socket 10.

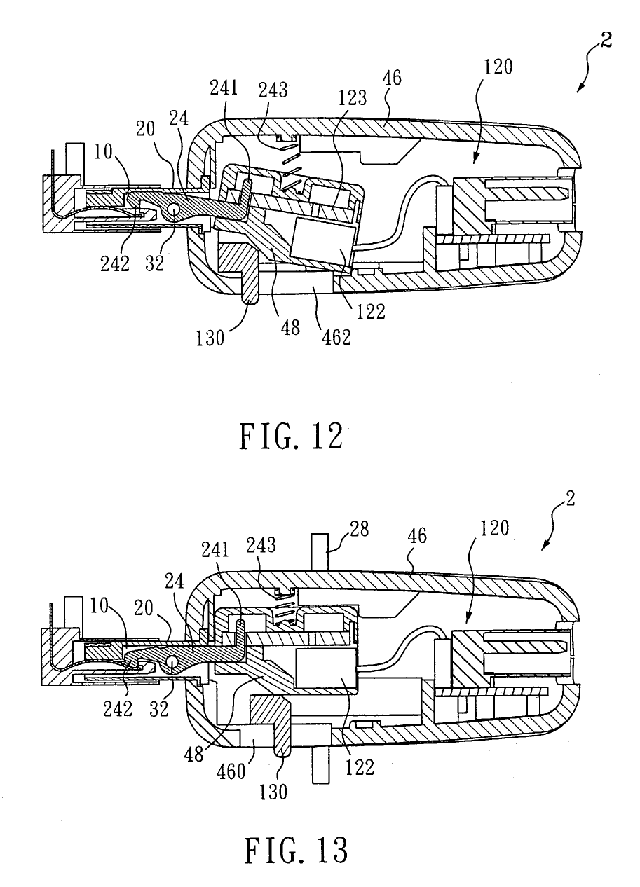

The fastener may be a locking arm 24 as illustrated. The locking arm 24 is movable, in relation to the closure 20, between a first position (as shown in FIG. 12) that allows the closure 20 to attach and detach from the slot 11 of the socket plug 10 and a second position (as shown in FIG. 13) that prevents the closure 20 inserted in the plug socket 10 from being detached from the slot 11 of plug socket 10. According to this embodiment, a pivot 32 is provided to the lock mechanism for pivoting the locking arm 24 and allowing the locking arm 24 of the closure 20 to pivot about the pivot 32. The locking arm 24 includes a control end 241 and a claw end 242 located at its free end.

Similarly, the lock mechanism may be of any type of locks so long as the lock mechanism is able to lock the locking arm 24 of the closure 20 to the plug socket 10. The constructions of the lock mechanism are not limited to those disclosed in the embodiments. The lock mechanism is assembled to the closure 20 and co-acts with the fastener. The lock mechanism is switchable between an unlocked state and a locked state. In the unlocked state, the lock mechanism forces the fastener to be restrained to the second position.

According to the embodiment shown in FIGS. 10-13, the lock mechanism includes a lock case 46, formed with at least one lock opening 22; a control key 130, formed with at least one corresponding lock opening 132 and being freely movable within the lock case 46 formed by a window 462, the control key 130 protruding out of the lock case 46 from the window 462 to be operated by a user; a control member 48, controlled by the control key 130 so as to move in relation to the lock case 46, wherein the control member 48 may urge against the control end 241 of the locking arm 24 for restraining the fastener/locking arm 24 to the second position.

In this embodiment, the control member 48 includes an electrical component 122 that is electrically connected to the closure 20 through the locking arm 24 and a circuit board 123, the electrical component 122 being electrically connected to the bypass interface 120. The control member 48 applies forces to the control end 241 of the locking arm 24 in response to the operation of the lock mechanism. In the unlocked state, the control member 48 is movable in relation to the lock case 46 and is clear from the control end 241 of the locking arm. The control key 130 controls the locked state and unlocked state of the securing device 2. The control member 48 is normally subjected to a force applied by a compression spring 243 to the control end 241, subjecting the claw end 242 to the state as shown in FIG. 12.

In use, after the closure 20 is inserted into the plug socket 10, the control key 130 is pushed to cause the control member 48 driving the locking arm 24 to pivot about the pivot 32, such that the claw end 242 of the locking arm 24 tightly attaches to the slot of the plug socket, that is, moving from the first position shown in FIG. 12 to the second position shown in FIG. 13.

When the fastener/locking arm is restrained to the second position, a connecting element 28 is passed through the lock opening 22 on the lock case 46 of the securing device 2, and through the lock opening 132 on the control key 130 at the same time, thereby limiting the movement of the control key 130 in relation to the securing device 2, as shown in FIG. 13.

The features that distinguish this embodiment from the prior embodiments include that the securing device 2 in this embodiment further includes the bypass interface 120 that is electrically connected to the closure 20 through an electrical component 122, and that the closure 20 is electrically connected to the contacts in the plug socket 10.

Therefore, after the hardware equipment or transmission lines are wrapped about a fixture by means of the connecting element 28, the communication equipment or computer may be connected to other hardware equipments or transmission lines for data transmission purposes.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A plug socket securing device, for use with an equipment provided with a plug socket having a slot formed by a resilient tab on the plug socket, comprising:
a closure, to be inserted into the plug socket for covering the plug socket;
at least one fastener, connected to the closure and being movable, in relation to the closure, between a first position allowing the fastener to attach and detach from the slot of the socket plug and a second position preventing the closure inserted in the plug socket from detaching from the plug socket; and
a lock mechanism, assembled to the closure for actuating the fastener, the lock mechanism being switchable between an unlocked state and a locked state, where in the unlocked state, the lock mechanism forces the fastener to be retrained into the second position.

2. The plug socket securing device according to claim 1, wherein the fastener is pivoted to the closure, and the fastener includes a claw end, the claw end being hooked to the slot of the plug socket when the fastener is at the second position.

3. The plug socket securing device according to claim 1, wherein the fastener is a resilient body connected to the closure, the fastener having a claw end at a free end thereof, the claw end being hooked to the slot of the plug socket when the fastener is at the second position and the free end being actuated by the lock mechanism.

4. The plug socket securing device according to claim 1, wherein the lock mechanism includes: a lock case, a control member movable in relation to the lock case for urging the fastener to the second position, and in the unlocked state, the control member being movable in relation to the lock case.

5. The plug socket securing device according to claim 4, wherein the lock mechanism is a key lock.

6. The plug socket securing device according to claim 1, wherein the lock mechanism includes a lock case, a control member movable in relation to the lock case for urging the fastener to the second position, the lock case being formed with a lock opening, through which a connecting element passes when the fastener is restrained at the second position for limiting movement of the control member, and the connecting element being connected to a fixture and not detachable from the lock opening.

7. The plug socket securing device according to claim 6, wherein the connecting element is a cable.

8. The plug socket securing device according to claim 6, wherein the lock mechanism is a drawing lock and includes a controller integrally formed to the control member for controlling the control member to move in a linear relation with respect to the lock case, and the lock opening is formed through corresponding locations of the lock case and the control member.

9. The plug socket securing device according to claim 6, wherein the lock mechanism is a rotary lock and includes a controller integrally formed to the control member for controlling the control member to rotate in a rotational relation with respect to the lock case, and the lock opening is formed through corresponding locations of the lock case and the control member.

10. A plug socket securing device, for use with an equipment provided with a plug socket having a slot formed by a resilient tab on the plug socket, comprising:
a closure, to be inserted into the plug socket for covering the plug socket, the closure being able to electrically connect to the plug socket;
at least one fastener, connected to the closure and being movable, in relation to the closure, between a first position allowing the closure to attach and detach from the slot of the socket plug and a second position preventing the closure inserted in the plug socket from detaching from the plug socket;
a lock mechanism, assembled to the closure for actuating the fastener, the lock mechanism being switchable between an unlocked state and a locked state, where in the unlocked state, the lock mechanism forces the fastener to be restrained to the second position;
a connecting element, having an end connected to the lock mechanism, and another end being connected to a fixture; and
a bypass interface, electrically connected to the closure by means of an electrical component and serving as a connection between other hardware or transmission lines and the plug socket when the closure covers the plug socket.

11. The plug socket securing device according to claim 10, wherein the fastener is pivoted to the closure, and the fastener includes a claw end, the claw end being hooked to the slot of the plug socket when the fastener is at the second position.

12. The plug socket securing device according to claim 10, wherein the fastener is a resilient body connected to the closure, the fastener having a claw end at a free end thereof, the claw end being hooked to the slot of the plug socket when the fastener is at the second position and the free end being actuated by the lock mechanism.

13. The plug socket securing device according to claim 10, wherein the lock mechanism includes: a lock case, a control member movable in relation to the lock case for urging the resilient body to the second position, and in the unlocked state, the control member being movable in relation to the lock case.

14. The plug socket securing device according to claim 13, wherein the lock mechanism is a key lock.

15. The plug socket securing device according to claim 10, wherein the lock mechanism includes a lock case, a control member movable in relation to the lock case for urging the fastener to the second position, the lock case being formed with a lock opening, through which the connecting element passes when the fastener is restrained at the second position for limiting movement of the control member, and the connecting element being connected to a fixture and not detachable from the lock opening.

16. The plug socket securing device according to claim 15, wherein the connecting element is a cable.

17. The plug socket securing device according to claim 15, wherein the lock mechanism is a drawing lock and includes a controller integrally formed to the control member for controlling the control member to move in a linear relation with respect to the lock case, and the lock opening is formed through corresponding locations of the lock case and the control member.

18. The plug socket securing device according to claim 15, wherein the lock mechanism is a rotary lock and includes a controller integrally formed to the control member for controlling the control member to rotate in a rotational relation with respect to the lock case, and the lock opening is formed through corresponding locations of the lock case and the control member
